(19) United States
(12) Patent Application Publication
(10) Pub. No.: US 2025/0383430 A1
(43) Pub. Date: Dec. 18, 2025

(54) FMCW LIDAR SYSTEM, ELECTRONIC DEVICE AND METHOD FOR DRIVING A LIDAR SYSTEM

(71) Applicant: ams International AG, Jona (CH)

(72) Inventors: Loic PERRUCHOUD, Rechy (CH); Jens GEIGER, Thalwil (CH)

(21) Appl. No.: 19/107,107

(22) PCT Filed: Aug. 29, 2023
(86) PCT No.: PCT/EP2023/073699

§ 371 Date: Feb. 27, 2025

(30) Foreign Application Priority Data
Aug. 31, 2022 (DE) 10 2022 121 992.5

(51) Int. Cl. G01S 7/4911; G01S 17/32; G01S 17/58

(52) U.S. Cl. CPC G01S 7/4911; G01S 17/32; G01S 17/58

(57) ABSTRACT

A LIDAR system includes a laser device configured to emit a transmit signal towards an object. A frequency of the transmit signal is variable by varying a current injected in the laser device. The LIDAR system also includes a laser driving system for driving the laser device. The LIDAR system further includes a receiver configured to receive an input signal. The input signal is based on a superposition of the transmit signal and a reflected signal reflected by the object. The laser driving system is configured to supply the current having an intensity varying in accordance with a combination at different timings of a changing frequency of the transmit signal with time and a constant frequency with time. A speed and a distance between the object and the receiver are configured to be determined from the input signal.

Tracking the poses of devices like AR/VR headsets or controllers, robots or other mobile devices is important for many applications. Odometry or Simultaneous localization and mapping (SLAM) techniques are used for such tasks. These techniques associate perception and movement and can take advantage of various sensors.

FMCW (“Frequency Modulated Continuous Wave”) LIDAR (“Light Detection and Ranging”) systems, particularly SMI LIDAR systems (“Self Mixing Interferometry”) can measure distance or speed of objects. Distance provides information on the structure of the environment while speed provides information on the movement.

### SUMMARY

It is an object of the present invention to provide an improved LIDAR system, an improved SLAM system, an improved electronic device and an improved method for driving a LIDAR system.

According to embodiments, the above objects are achieved by the claimed matter according to the independent claims.

A LIDAR system according to embodiments comprises a laser device configured to emit a transmit signal towards an object, a frequency of the transmit signal being variable by varying a current injected in the laser device, a laser driving system for driving the laser device, and a receiver configured to receive an input signal, the input signal being based on a superposition of the transmit signal and a reflected signal reflected by the object. The laser driving system is configured to supply the current having an intensity varying in accordance with multiple different modulation patterns at different timings, the modulation patterns representing a frequency change of the transmit signal with time or in accordance with a combination at different timings of a changing frequency with time and a constant frequency. A speed and a distance between the object and the receiver are configured to be determined from the input signal.

According to embodiments, the receiver may comprise a processing unit that is configured to determine the speed and the distance between the object and the receiver from the input signal. According to further embodiments, the processing unit that is configured to determine a speed and a distance between the object and the receiver from the input signal may be a component of a remote device, e.g. a controller.

For example, the different modulation patterns may correspond to different triangles representing a change of the frequency of the transmit signal with time. Due to this specific implementation of the laser driving system, speed and distance between the receiver or a photodetector and the object may be determined. In particular, the speed may be determined while evaluating the input signal in a frequency range that is also used for determining the distance. At the same time, ambiguities while determining speed and distance may be reduced or avoided.

For example, the laser device may comprise an array of laser elements, and the receiver may comprise an array of detector elements. Due to this configuration, a linear velocity of the receiver may be determined. For example, the processing unit may be configured to determine the linear velocity of the LIDAR system, e.g. when enough objects are stationary and do not move.

According to embodiments, a frequency excursion between a maximum frequency of the transmit signal and a minimum frequency of the transmit signal is from 0 to 200 GHz.

For example, at least two of the different modulation patterns may correspond to triangles having different maximum frequencies of the transmit signal. According to further embodiments, at least two of the different modulation patterns may correspond to triangles having different modulation periods. In this respect, the modulation period may correspond to a time distance between minimum frequencies of the transmit signal, respectively.

According to embodiments, the processing unit may be configured to determine calculation results for speed and distance between the object and the receiver from the input signal for each modulation pattern. The processing unit may further be configured to determine valid calculation results from the determined calculation results.

According to embodiments, a simultaneous localization and mapping (SLAM) system comprises the LIDAR system as described.

Further, an electronic device may comprise the LIDAR system as explained above. For example, the electronic device may be a VR/AR (“Virtual Reality/Augmented Reality”) headset, for example, in combination with a suitable controller or may be a robot.

According to embodiments, a method is suitable for driving a LIDAR system comprising a laser device configured to emit a transmit signal towards an object, a frequency of the transmit signal being variable by varying a current injected in the laser device, and a receiver configured to receive an input signal, the input signal being based on a superposition of the transmit signal and a reflected signal reflected by the object. The method comprises supplying the current having an intensity varying in accordance with multiple different modulation patterns at different timings, the modulation patterns representing a frequency change of the transmit signal with time or in accordance with a combination at different timings of a modulation pattern representing the frequency change of the transmit signal with time and a constant frequency.

For example, at least two of the different modulation patterns correspond to triangles having different maximum frequencies of the transmit signal.

According to embodiments, at least two of the different modulation patterns correspond to triangles having different modulation periods corresponding to a time distance between minimum frequencies of the transmit signal, respectively.

### BRIEF DESCRIPTION OF THE DRAWINGS

The accompanying drawings are included to provide a further understanding of embodiments of the invention and are incorporated in and constitute a part of this specification. The drawings illustrate the embodiments of the present invention and together with the description serve to explain the principles. Other embodiments of the invention and many of the intended advantages will be readily appreciated, as they become better understood by reference to the following detailed description. The elements of the drawings are not necessarily to scale relative to each other. Like reference numbers designate corresponding similar parts.

FIG. 1A shows a schematic view of a LIDAR system according to embodiments.

FIG. 1B shows a schematic view of a LIDAR system according to further embodiments.

FIG. 2A shows a schematic view of a LIDAR sensor that may be a component of the LIDAR system according to embodiments.

FIG. 2B illustrates a method for determining a linear velocity.

FIG. 3A shows a chart of a transmit signal and a reflected signal, a chart of a beat frequency and an example of a detection signal in dependence of time.

FIG. 3B to 3E illustrate waveforms representing a frequency change of time.

FIGS. 3F and 3G illustrate further examples of waveforms of a current signal.

FIG. 4A shows a SLAM system according to embodiments.

FIG. 4B shows a robot according to embodiments.

### DETAILED DESCRIPTION

In the following detailed description reference is made to the accompanying drawings, which form a part hereof and in which are illustrated by way of illustration specific embodiments in which the invention may be practiced. In this regard, directional terminology such as “top”, “bottom”, “front”, “back”, “over”, “on”, “above”, “leading”, “trailing” etc. is used with reference to the orientation of the Figures being described. Since components of embodiments of the invention can be positioned in a number of different orientations, the directional terminology is used for purposes of illustration and is in no way limiting. It is to be understood that other embodiments may be utilized and structural or logical changes may be made without departing from the scope defined by the claims.

The description of the embodiments is not limiting. In particular, elements of the embodiments described hereinafter may be combined with elements of different embodiments.

As employed in this specification, the terms “coupled” and/or “electrically coupled” are not meant to mean that the elements must be directly coupled together-intervening elements may be provided between the “coupled” or “electrically coupled” elements. The term “electrically connected” intends to describe a low-ohmic electric connection between the elements electrically connected together.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The terms “lateral” and “horizontal” as used in this specification intends to describe an orientation parallel to a first surface of a substrate or semiconductor body. This can be for instance the surface of a wafer or a die.

The term “vertical” as used in this specification intends to describe an orientation which is arranged perpendicular to the first surface of a substrate or semiconductor body.

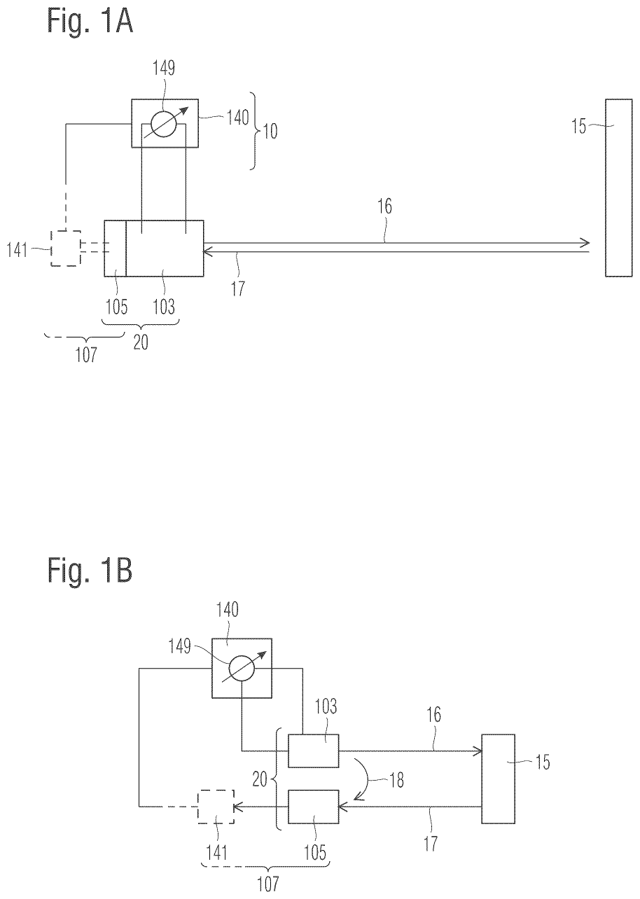

FIG. 1 illustrates a LIDAR system 10 according to embodiments. The LIDAR system 10 comprises a laser device 103 that is configured to emit a transmit signal 16 towards an object 15. A frequency of the transmit signal 16 is variable by varying a current injected in the laser device 103. The system further comprises a laser driving system 140 for driving the laser device 103. The LIDAR system further comprises a receiver 105 which is configured to receive an input signal. The input signal is based on a superposition of the transmit signal 16 and a reflected signal 17 that has been reflected by the object 15. The laser driving system 140 is configured to supply the current having an intensity varying in accordance with multiple different modulation patterns representing a frequency change of the transmit signal with time or in accordance with a combination of a changing frequency of the transmit signal with time and a constant current intensity. For example, the current may be supplied at an intensity varying in accordance with multiple different triangles representing change the frequency of the transmit signal 16 with time. According to further embodiments, the current intensity may vary in accordance with a triangle representing the frequency change of the transmit signal 16 and a constant current intensity. A speed and a distance between the object 15 and the receiver 107 may be determined from the input signal.

According to embodiments, the receiver 107 may comprise a processing unit 141 which is configured to determine a speed and a distance between the object 15 and the receiver 107 from the input signal.

According to further embodiments, the received input signal or a signal generated in dependence from the received input signal may be transmitted to a processing unit 141 that does not form a component of the LIDAR system 10 itself. For example, the processing unit 141 may be a component of a controller, e.g. a controller of system comprising a VR/AR headset. According to further implementations, the processing unit 141 may be a component of a computer controlling an electronic device comprising the LIDAR system 10.

For example, the laser device 103 comprise a VCSEL (“vertical cavity surface emitting semiconductor laser”) which is based on semiconductor materials and which is configured to emit electromagnetic radiation at a wavelength be varied by varying the current injected into the VCSEL. The laser driving system 140 may comprise a current source 149 that may be controlled to supply a current at a predetermined intensity. The receiver 107 may comprise a photodetector 105 which is configured to detect the input signal.

As is illustrated in FIG. 1A, the laser device 103 may be arranged over the photodetector 105. In more detail, for example, the photodetector 105 may be arranged on a side of the laser device 103 remote from an emission surface of the laser device 103.

The input signal is based on a superposition of the transmit signal 16 and a reflected signal 17 reflected by the object 15. For example, the LIDAR sensor 20 comprising the laser device 103 and the photodetector 105 may be based on self-mixing interference (SMI).

According to further embodiments, the photodetector 105 may be arranged on a light-emission side of the laser device 103. Also, in this case, the input signal is based on a superposition of the transmit signal 16 and the reflected signal 17.

FIG. 1B illustrates a further configuration of the LIDAR system 10 and the LIDAR sensor 20 comprising the laser device 103 and the photodetector 105. As is illustrated, according to embodiments, the laser device and the photodetector 105 are not stacked but may be arranged in a close spatial relationship in a direction perpendicular to an emission direction of the transmit signal. According to the configuration illustrated in FIG. 1B, the reflected signal 17 is superposed onto a reference signal 18 that may be e.g. split from the transmit beam 16 by means of a beam splitter or in any further arbitrary manner. According to the implementation illustrated in FIG. 1B, the reflected signal 17 is coherently superposed with the reference beam and, hence, implement self-mixing interference is implemented. As is clearly to be understood, further configurations that enable a coherent superposition of the reflected signal 17 with a portion of the transmit signal 16 may be employed.

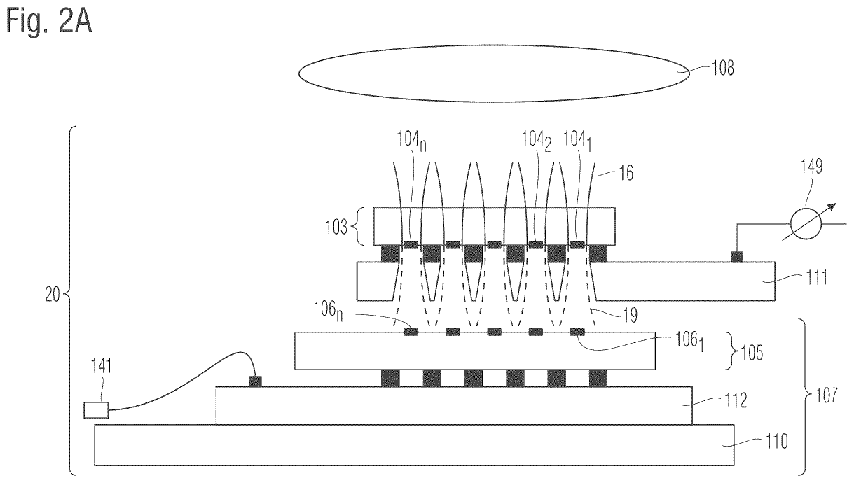

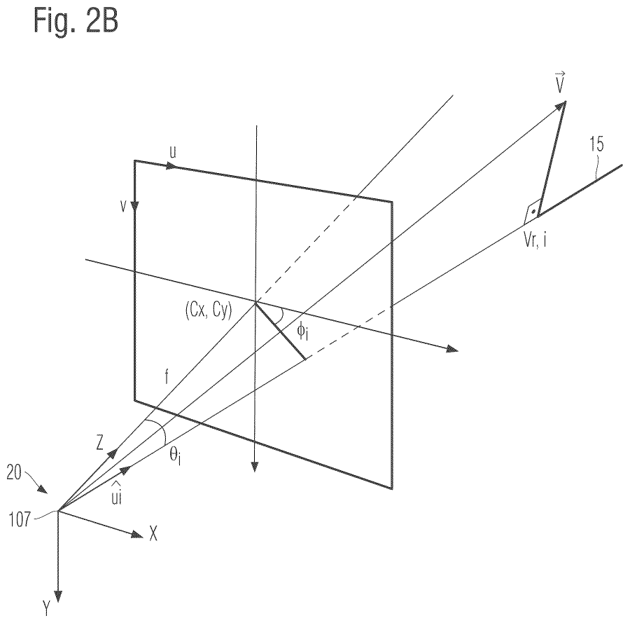

Also according to embodiments illustrated in FIG. 2B, the processing unit 141 may be a component of the LIDAR system 10 or may be a component of a separate device.

FIG. 2A illustrates an example of a configuration of a LIDAR sensor 20. As is shown in FIG. 2A, the laser device 103 comprises an array of laser elements 104₁, 104₂, . . . , 104ₙ. According to the configuration shown in FIG. 2A, the laser elements 104 are arranged along one horizontal direction or along a 2-dimensional array. The transmit signal 16 emitted by the laser elements is directed towards a projection lens 108 that may be used for collimating the transmit signal 16. For example, the single laser elements 104ᵢ may be implemented at VCSELs that are mounted to a suitable carrier. The single laser elements may be electrically connected via a laser fanout 111 to the current source 149 forming a component of the laser driving system 140.

The elements illustrated in FIG. 2A may be arranged so that the detector elements 106₁, 106₂, . . . 106ₙ, are arranged in a focal plane of the image sensor 20. The position of the focal plane may be determined by the projection lens 108. A superposition of the transmit signal 16 and the reflected signal 17 may form the input signal 19 that is received by the single detector elements 106₁, 106₂, . . . , 106ₙ. The detector elements 106₁, . . . , 106ₙ form a component of the photodetector 105. The detector elements 106i may be electrically connected via a detector fanout 112 to a processing unit 141. In more detail, a photocurrent generated by the single detector elements 106ᵢ may be processed by the processing unit 141. The photodetector 105 and further components of the receiver 107 may be arranged over a carrier 110.

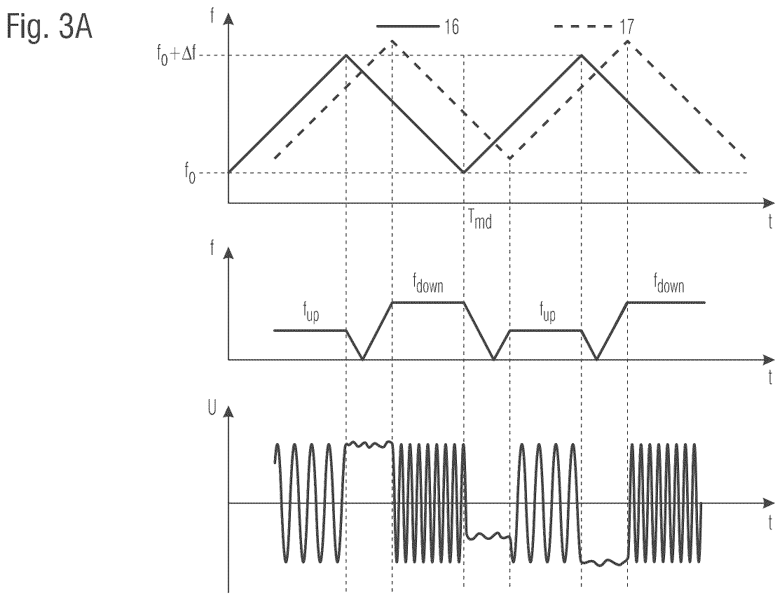

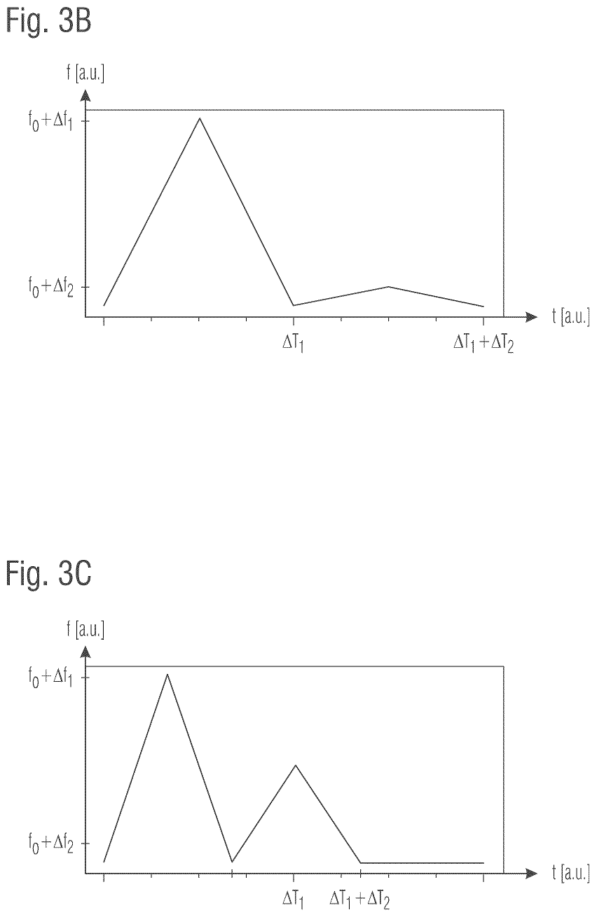

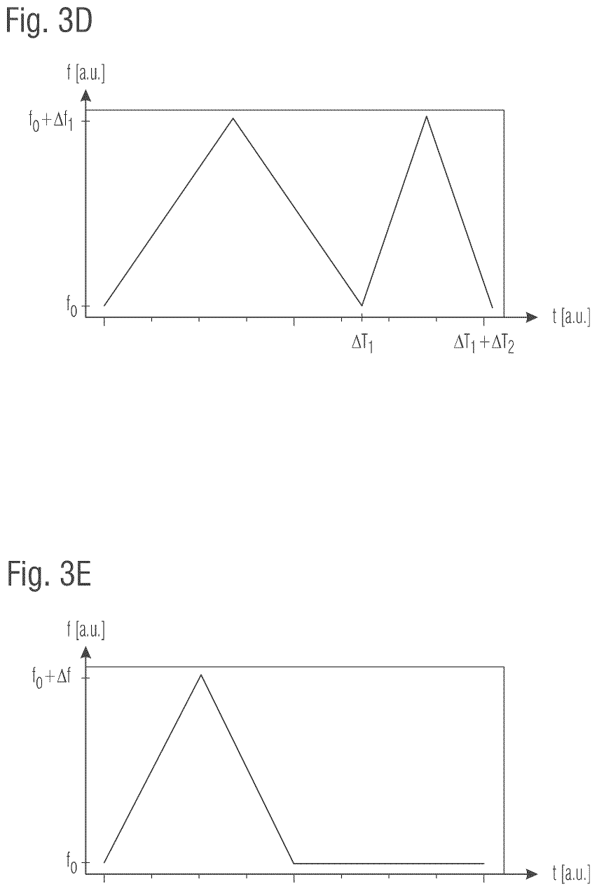

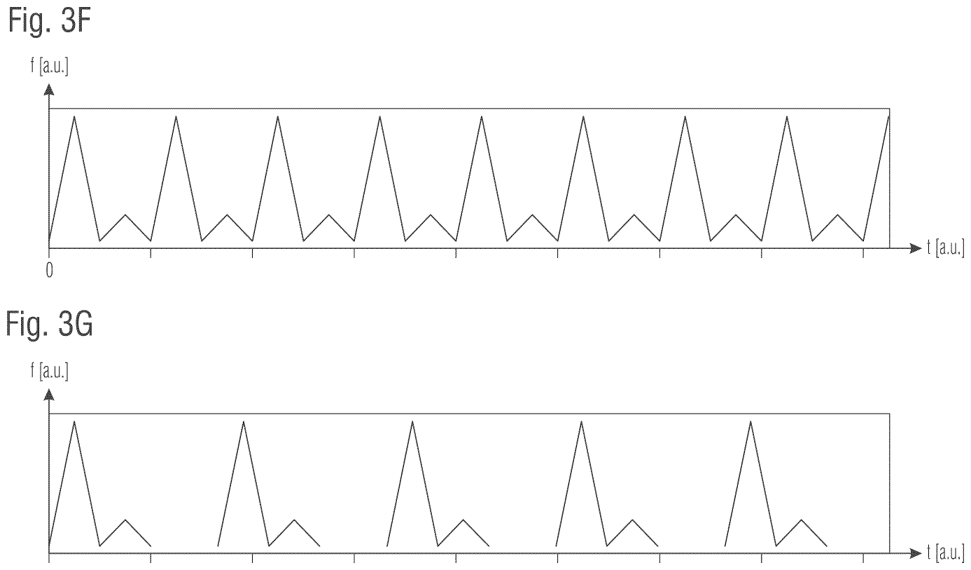

As will be explained in the following with reference to FIG. 3A, distance and speed of the object 15 may be determined from the input signal. In more detail, by employing the configuration, a radial velocity vᵣ may be determined.

FIG. 2B shows a diagram illustrating the relationship between the radial velocity vᵣᵢ and the linear velocity v. The radial velocity vᵣᵢ refers to the relative velocity between the sensor 20/receiver 107, in particular, the detector element 106ᵢ and the object 15 in the scene projected into the ray direction. The index “i” denotes the ray of the transmit signal 16 emitted by a corresponding one of the laser elements 104ᵢ illustrated in FIG. 2A. When the scene is static, the relation between the linear velocity of the sensor v=(vₓ, v_{y}, v_{z}) and the N measured radial velocities measured by each of the detector elements 106ᵢ is given by the following equation system:

$$( \begin{matrix}{v}_{r , 1} \\ ⋮ \\ {v}_{r , N}\end{matrix} ) = ( \begin{matrix}cos ( {ϕ}_{1} ) sin ( {θ}_{1} ) & sin ( {ϕ}_{1} ) sin ( {θ}_{1} ) & cos ( {ϕ}_{1} ) \\ ⋮ & ⋮ & ⋮ \\ cos ( {ϕ}_{N} ) sin ( {θ}_{N} ) & sin ( {ϕ}_{N} ) sin ( {θ}_{N} ) & cos ( {ϕ}_{N} )\end{matrix} ) \cdot ( \begin{matrix}{v}_{x} \\ {v}_{y} \\ {v}_{z}\end{matrix} )$$

wherein Φᵢ and Θᵢ are angles that indicate the direction of each ray. The rays might be coming from a single sensor array or from an arrangement of multiple sensors.

In FIG. 2B, Cx and Cy are the coordinates of the principal point (intersection of the optical axis with the image plane) and f is the focal length. The direction of each ray is defined by the angles Φ and Θ in an equation that directly depends on the focal width and on the position of each ray on the (virtual) focal plane. Theses angles are determined by calibration of the system.

Accordingly, by solving this system e.g. using at least squares or further methods, the linear velocity of the sensor may be determined.

FIG. 3A shows a chart representing the frequency of the transmit signal 16 and the reflected signal 17 with time. Generally, in FMCW LIDAR systems using the Doppler effect, the object may be detected by determining the frequency difference between the transmit signal and the reflected signal. In order to simultaneously detect speed and distance of the object, the frequency of the transmit signal is modulated according to a sawtooth or triangular shape as illustrated in FIG. 3A. As is seen, the frequency of the reflected signal 17 is delayed and offset with respect to the transmit signal 16.

The middle portion of FIG. 3A illustrates the frequency difference between the two signals with time. The difference during up-ramping the frequency is denoted as “fᵤₚ”, the difference during down-ramping the frequency is denotes as “f_{down}”. The lower portion of FIG. 3A shows an example of a measurement signal, e.g. a voltage signal that may be generated using an output of the photodetector 105. As is seen, the detection signal is periodic having a frequency corresponding to the beat signal, i.e. corresponding to the frequency difference between the transmit signal and the reflected signal 17, as is e.g. illustrated in the upper portion of FIG. 3A.

Generally, distance and radial speed may be determined using the following formula

$${f}_{up} = \vert {f}_{speed} - {f}_{distance} \vert ,$$

$${f}_{down} = \vert {f}_{speed} + {f}_{distance} \vert$$

$${f}_{distance} = \frac{4 {f}_{mod} Δ f}{c} r ,$$

$${f}_{speed} = \frac{2}{λ} {v}_{r}$$

In the above formulae, the following ranges may be assumed:

| Variable | Typical Value | |
|---|---|---|
| Distance r | 0-10 | m |
| Radial velocity vᵣ | 0-10 | m/s |
| Modulation frequency f_{mod} | 100-1000 | Hz |
| Frequency excursion Δf | 0-200 | GHz |
| Wavelength λ | 1000 | nM |
| Speed of light c | 3*10⁸ | m/s |
| Distance contribution to beat | 0-20 | MHz |
| frequency f_{distance} | | |
| Speed contribution to beat | 0-20 | MHz |
| frequency f_{speed} | | |

wherein f_{mod} corresponds to 1/T_{mod}. Generally, there are three possible solutions for the distance and speed contribution
1. If f_{speed}≥f_{distance}:

$${f}_{distance} = \frac{{f}_{down} - {f}_{up}}{2} ,$$

2. If f_{distance}>f_{speed}≥−f_{distance}:

$${f}_{distance} = \frac{{f}_{down} + {f}_{up}}{2} ,$$

3. If −f_{distance}>f_{speed}:

$${f}_{distance} = - \frac{{f}_{down} - {f}_{up}}{2} ,$$

As has been indicated above, there are range-speed ambiguities. In more detail, there may be more than one solution to the above equations.

In order to solve this problem, the laser driving system 140 is configured to supply the current having an intensity varying in accordance with multiple different triangles representing the frequency change of the transmit signal with time or in accordance with a combination of a triangle representing the frequency change of the transmit signal with time and a constant current intensity.

In the following, examples of frequency-time characteristics will be explained in more detail. As is e.g. illustrated in FIG. 3B, the current and hence the frequency is modulated so that the frequency increases to a value f₀+Δf₁ and then decreases to f₀ at ΔT₁. Thereafter, the current increases so that the frequency increases to f₀+Δf₂ and decreases to f₀ at ΔT₁+ΔT₂. Using this waveform, ambiguities may be resolved, since there are two values for f_{mod} and two values for Δf while the system is maintained. FIG. 3C shows a further waveform according to which first the frequency increases to a value f₀+Δf₁. Thereafter, the frequency decreases to f₀ at ΔT₁. Thereafter, the frequency increases to f₀+Δf₂ and then decreases to f₀ at ΔT₁+ΔT₂. Thereafter, the frequency is at a constant value which means that Δf=0 for t>ΔT₁+ΔT₂.

FIG. 3D shows a further waveform. In particular, according to this example, ΔT₂<TΔ₁.

FIG. 3E further shows a waveform according to which the intensity varies in accordance with a combination of a triangle representing the frequency change of the transmit signal with time and a constant current intensity. In particular, the frequency first raises to a frequency f₀+Δf. Thereafter, the injected current decreases so that the frequency decreases to f₀. Thereafter, the transmit signal has a constant frequency f₀.

According to further the implementations, time in which the frequency is increased from f₀ to f₀+Δf may differ from the time in which the frequency is decreased from f₀+Δf to f₀ according to different modulation patterns. For example, f_{MOD} may be identical or different for the different modulation patterns.

After performing the measurements, e.g. using the above described waveforms, the measured signals may be evaluated, eliminating the solutions which lead to a negative distance.

According to embodiments, when the speed contribution is close to the distance contribution or the inverse distance contribution, the beat frequency may be too small to be measured, e.g. on the raising or falling ramp. In this case, this frequency may be set to zero as a best guess and approximated solutions for this modulation may be computed.

According to further embodiments, due to the use of different modulation patterns it may be possible to avoid that the beat frequency is too small for the same distance-speed conditions in the range of interest.

For example, if at least two solutions determined for the different modulation patterns are equal to or below a given threshold, the average of the common solution (without the approximated solutions) may be taken. If there are no common solutions, the result is to be considered as invalid.

This will be explained in more detail using the following table:

| Variable | Value | | | | | | | |
|---|---|---|---|---|---|---|---|---|
| Modulation | 1000 | | | Hz | | | | |
| frequency | | | | | | | | |
| f_{mod} | | | | | | | | |
| Wavelength | 1000 | | | nm | | | | |
| Speed of | 3e8 | | | m/s | | | | |
| light c | | | | | | | | |
| Frequency | 100 GHz | | | 10 GHz | | | 0 | |
| excursion Δf | | | | | | | | |
| Solution | 1 | 2 | 3 | 1 | 2 | 3 | 1 | 3 |
| f_{distance} [Hz] | 2e5 | 1.33e6 | −2e5 | 1.33e5 | 2e5 | −1.33e5 | — | — |
| Estimated | 0.15 | 1 | −0.15 | 1 | 1.5 | −1 | — | — |
| distance r | | | | | | | | |
| [m] | | | | | | | | |
| f_{speed} [Hz] | 1.33e6 | 2e5 | −1.33e6 | 2e5 | 1.33e5 | −2e5 | 2e5 | −2e5 |
| Estimated | 0.66 | 0.1 | −0.66 | 0.1 | 0.066 | −0.1 | 0.1 | −0.1 |
| radial | | | | | | | | |
| velocity | | | | | | | | |
| vᵣ [m/s] | | | | | | | | |

As is shown in the above table, by employing different modulation patterns, distance and radial velocity may be determined. Solution 3 at a frequency excursion of 100 GHz and solution 3 at a frequency excursion of 10 GHZ deliver negative distances. Hence, these solutions are rejected. Solution 2 at a frequency excursion of 100 GHz and solution 1 at a frequency excursion of 10 GHz and solution 1 at constant frequency deliver similar results. Hence, a distance of 1 m and a radial velocity of 0.1 m/s are determined as distance and speed.

Then, before calculating the linear velocity, stationary targets as objects 15 for reflecting the transmit beam 16 need to be detected. Erroneous measurements of measurements corresponding to moving objects are filtered out. This may be accomplished by removing measurements that deviate from the dominant velocity profile using known methods.

Thereafter, using the determined ranges and radial velocities, the linear velocity of the LIDAR sensor 20 may be determined.

FIG. 3F and 3G show further examples of modulation patterns. As is shown in FIG. 3F, the modulation pattern may be continuous. As is further shown in FIG. 3G, the signal may be frame-based. For example, at a frame time that is larger than the duration of e.g. two modulation patterns, 2 modulation patterns per measure may be employed. Thereafter, no measurement is performed until the next frame. The next new modulation patterns are then employed for the next frame.

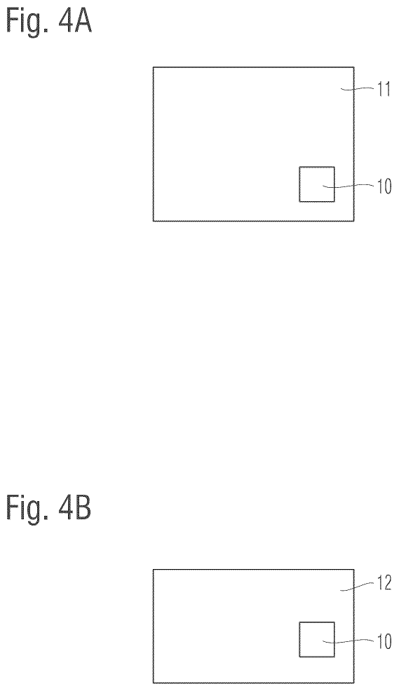

FIG. 4A shows an SLAM (Simultaneous Localization And Mapping) system according to embodiments. The SLAM system comprises the LIDAR system 10 as described herein above. Due to the use of the LIDAR system 10, it is possible to determine the linear velocity of the sensor. The SLAM system may comprise other sensors like an IMU (Inertial Measurement Unit) or a camera.

FIG. 4B illustrates an electronic device 12 according to embodiments. The electronic device 12 comprises the LIDAR system 10 as described herein above. Using the LIDAR system, the velocity and distance of the electronic device 12 with respect to an object may be precisely determined. For example, the electronic device 12 may be a VR/AR headset. In this case velocity and pose of the person, e.g. a player wearing the VR/AR headset may be precisely determined. In this case, the processing unit 141 may be a component of a controller that may further e.g. control content that is displayed or provided to the AR/VR headset. According to further embodiments, the electronic device 12 may be a robot.

While embodiments of the invention have been described above, it is obvious that further embodiments may be implemented. For example, further embodiments may comprise any subcombination of features recited in the claims or any subcombination of elements described in the examples given above. Accordingly, this spirit and scope of the appended claims should not be limited to the description of the embodiments contained herein.

### List of References

10 LIDAR system
11 SLAM system
12 electronic device
15 object
16 transmit signal
17 reflected signal
18 reference signal
19 input signal
20 LIDAR sensor
103 laser device
104₁ . . . 104ₙ laser element
105 photodetector
106₁ . . . 106ₙ detector element
107 receiver
108 projection lens
110 carrier
111 laser fanout
112 detector fanout
140 laser driving system
141 processing unit
149 current source

1. A LIDAR system comprising:
a laser device configured to emit a transmit signal towards an object, a frequency of the transmit signal being variable by varying a current injected in the laser device;
a laser driving system for driving the laser device; and
a receiver configured to receive an input signal, the input signal being based on a superposition of the transmit signal and a reflected signal reflected by the object,
wherein the laser driving system is configured to supply the current having an intensity varying in accordance with a combination at different timings of a changing frequency of the transmit signal with time and a constant frequency with time,
wherein a speed and a distance between the object and the receiver are configured to be determined from the input signal.

2. The LIDAR system according to claim 1, wherein the receiver comprises a processing unit that is configured to determine the speed and the distance between the object and the receiver from the input signal.

3. The LIDAR system according to claim 1, wherein the laser device comprises an array of laser elements, and the receiver comprises an array of detector elements, wherein the processing unit is configured to determine a linear velocity between the receiver and the object.

4. The LIDAR system according to claim 1, wherein a frequency excursion Δf between a maximum frequency of the transmit signal and a minimum frequency of the transmit signal is from 0 to 200 GHz.

5. The LIDAR system according to claim 1, wherein the laser driving system is further configured to supply the current having an intensity in accordance with multiple different modulation patterns at different timings, the modulation patterns representing a frequency change of the transmit signal with time and at least two of the different modulation patterns correspond to triangles having different maximum frequencies of the transmit signal, respectively.

6. The LIDAR system according to claim 5, wherein at least two of the different modulation patterns correspond to triangles having different modulation periods corresponding to a time distance between minimum frequencies of the transmit signal, respectively.

7. The LIDAR system according to claim 2, wherein the processing unit is configured to determine calculation results for speed and distance between the object and the receiver from the input signal for each modulation pattern and to determine valid calculation results from the determined calculation results.

8. A simultaneous localization and mapping (SLAM) system comprising the LIDAR system according to claim 1.

9. An electronic device comprising the LIDAR system according to claim 1.

10. The electronic device according to claim 9, being selected from an AR/VR headset and a robot.

11. A method for driving a LIDAR system comprising a laser device configured to emit a transmit signal towards an object, a frequency of the transmit signal being variable by varying a current injected in the laser device; and
a receiver configured to receive an input signal, the input signal being based on a superposition of the transmit signal and a reflected signal reflected by the object,
the method comprising:
supplying the current having an intensity varying in accordance with combination at different timings of a changing frequency of the transmit signal with time and a constant frequency with time.

12. The method according to claim 11, further comprising supplying the current having an intensity varying in accordance with multiple different modulation patterns at different timings, the different modulation patterns representing a frequency change of the transmit signal with time, wherein at least two of the different modulation patterns correspond to triangles having different maximum frequencies of the transmit signal.

13. The method according to claim 11, wherein at least two of the different modulation patterns correspond to triangles having different modulation periods corresponding to a time distance between minimum frequencies of the transmit signal, respectively.
